(19) United States
(12) Patent Application Publication
(10) Pub. No.: US 2005/0264167 A1
(43) Pub. Date: Dec. 1, 2005

(54) Electron emission device

(76) Inventors: Seung-Joon Yoo, Suwon-si (KR); Jong-Sick Choi, Suwon-si (KR); Jin-Min Park, Suwon-si (KR); Soo-Joung Lee, Suwon-si (KR); Jung-Ho Kang, Suwon-si (KR); Su-Kyung Lee, Suwon-si (KR)

Correspondence Address: Robert E. Bushnell;Suite 300, 1522 K Street, N.W., Washington, DC, 20005, US

(21) Appl. No.: 11/137,449

(22) Filed: May 26, 2005

(30) Foreign Application Priority Data
May 31, 2004 (KR) 10-2004-0039039

(51) Int. Cl. H01J 1/62

(52) U.S. Cl. 313/496; 313/114

(57) ABSTRACT

An electron emission device includes a first substrate having an electron emission unit for emitting electrons, and a second substrate facing the first substrate and having a light emission unit for emitting visible rays due to the electrons emitted by the electron emission unit. The light emission unit has a plurality of reflective layers formed on a surface of the second substrate facing the first substrate, and phosphor layers formed on the surface of the second substrate between the reflective layers as well as on lateral sides of the reflective layers. The reflective layer is formed of an achromatic color, particularly a white color. Black layers are disposed between the second substrate and the reflective layers.

### CLAIM OF PRIORITY

This application makes reference to, incorporates the same herein, and claims all benefits accruing under 35 U.S.C. § 119 from an application ELECTRON EMISSION DEVICE earlier filed in the Korean Intellectual Property Office on May 31, 2004 and there duly assigned Serial No. 10-2004-0039039.

### BACKGROUND OF THE INVENTION

1. Technical Field

The present invention relates to an electron emission device and, in particular, to an electron emission device which has an improved light emission unit to enhance the screen luminance.

2. Related Art

Generally, electron emission devices are classified into a first type where a hot cathode is used as an electron emission source, and a second type where a cold cathode is used as the electron emission source.

Among the second type electron emission devices, there are a field emitter array (FEA) type, a surface conduction emission (SCE) type, a metal-insulator-metal (MIM) type, and a metal-insulator-semiconductor (MIS) type.

The MIM type and the MIS type electron emission devices have a metal/insulator/metal (MIM) electron emission structure and a metal/insulator/semiconductor (MIS) electron emission structure, respectively. When voltages are applied to the metallic layers or to the metallic and the semiconductor layers, electrons are transferred and accelerated from the metallic layer or the semiconductor layer, having a high electric potential, to the metallic layer having a low electric potential, thereby producing the electron emission.

The SCE type electron emission device includes first and second electrodes formed on a substrate and facing each other, and a conductive thin film disposed between the first and the second electrodes. Micro-cracks are formed in the conductive thin film to produce electron emission regions. When voltages are applied to the electrodes while causing an electric current to flow to the surface of the conductive thin film, electrons are emitted from the electron emission regions.

The FEA type electron emission device is based on the principle that, when a material having a low work function or a high aspect ratio is used as an electron emission source, electrons are easily emitted from the material due to production of an electric field under vacuum conditions. A front sharp-pointed tip structure based on molybdenum Mo or silicon Si, or a carbonaceous material, such as carbon nanotube, graphite or diamond-like carbon, has been developed for use as the electron emission source.

The cold cathode-based electron emission devices basically have first and second substrates forming a vacuum vessel. Electron emission regions, and driving electrodes for controlling electron emission in the electron emission regions, are formed on the first substrate. Phosphor layers are formed on the second substrate together with an anode electrode for maintaining the phosphor layers in a high potential state. The anode electrode receives a plus (+) voltage of several hundred to several thousand volts, and accelerates the electrons emitted from the electron emission regions toward the phosphor layers.

A recent trend relates to the formation of an anode electrode, based on an aluminum Al-based metallic thin film, on the surface of phosphor layers facing the first substrate so as to enhance the screen luminance. The anode electrode reflects the visible rays, radiated from the phosphor layers to the first substrate, toward the second substrate, thereby enhancing the screen luminance.

However, as the electrons emitted from the side of the first substrate reach the phosphor layers via the anode electrode, some electrons suffer energy loss while passing the anode electrode so that they do not reach the phosphor layers. Accordingly, a high voltage of 6 kV or more has to be applied to the anode electrode in order to make the electrons passing the anode electrode reach the phosphor layers with sufficient energy.

When the high voltage of 6 kV or more is applied to the anode electrode, unintended electron emission may be caused in the electron emission regions due to the high intensity electric field formed by the anode voltage. Consequently, electrons are undesirably emitted from the electron emission regions at the off state pixels, and light-emit the phosphor layers, thereby causing the so-called diode light emission and screen display failure. Such a problem is more serious in the FEA type electron emission device.

### SUMMARY OF THE INVENTION

In one exemplary embodiment of the present invention, there is provided an electron emission device which lowers the voltage of the anode electrode so as to inhibit diode light emission while enhancing light emission efficiency, thereby heightening screen luminance.

In an exemplary embodiment of the present invention, the electron emission device includes a first substrate with an electron emission unit for emitting electrons, and a second substrate facing the first substrate with a light emission unit for emitting visible rays due to the electrons emitted by the electron emission unit. The light emission unit has a plurality of reflective layers formed on a surface of the second substrate facing the first substrate, and phosphor layers formed on the second substrate between the reflective layers.

The reflective layer is formed of an achromatic color, preferably a white color.

The phosphor layer is preferably formed on the lateral sides of the reflective layers, and black layers are preferably disposed between the second substrate and the reflective layers.

An anode electrode is formed on the entire surface of the second substrate with a metallic material such that the metallic material-based anode electrode covers the phosphor layers and the reflective layers. Alternatively, the anode electrode may be formed of a transparent material on a surface of the phosphor layers and the reflective layers facing the substrate.

In another exemplary embodiment of the present invention, the electron emission device includes a first substrate with an electron emission unit for emitting electrons, and a second substrate facing the first substrate with a light emission unit for emitting visible rays due to the electrons emitted by the electron emission unit. The light emission unit has a plurality of black layers formed on a surface of the second substrate facing the first substrate, and phosphor layers formed on the surface of the second substrate between the black layers, as well as on the lateral sides of the black layers.

An anode electrode is formed on the entire surface of the second substrate with a metallic material such that the metallic material-based anode electrode covers the phosphor layers and the black layers. Alternatively, the anode electrode may be formed of a transparent material on a surface of the phosphor layers and the black layers facing the second substrate.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial sectional view of an electron emission device according to a first embodiment of the present invention;

FIG. 2 is a partial sectional view of an electron emission device according to a second embodiment of the present invention;

FIG. 3 is a partial sectional view of an electron emission device according to a third embodiment of the present invention; and

FIG. 4 is a partial sectional view of an electron emission device according to a fourth embodiment of the present invention.

### DETAILED DESCRIPTION OF THE INVENTION

The present invention will be described more fully hereinafter with reference to the accompanying drawings, in which preferred embodiments of the invention are shown.

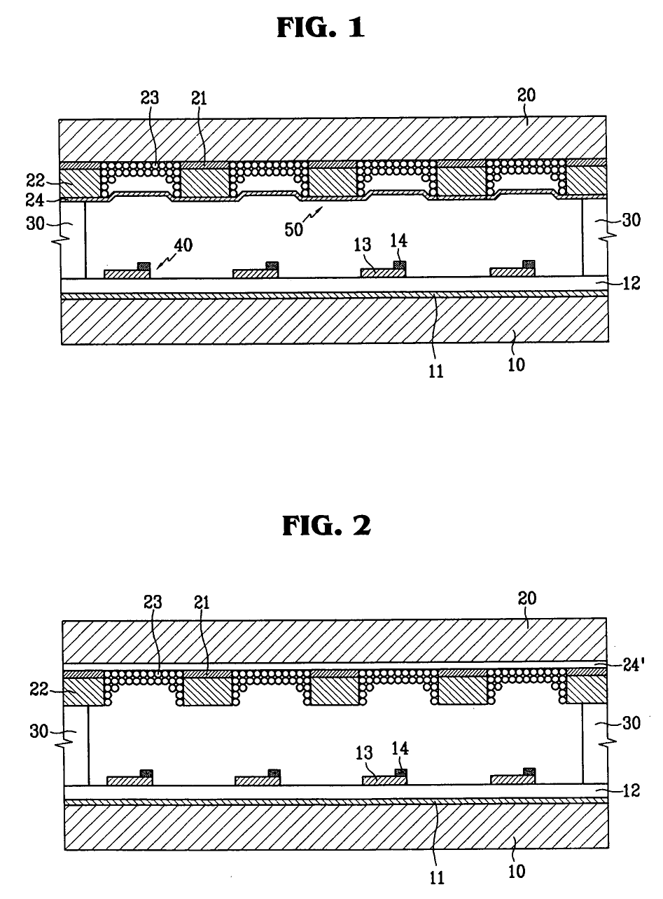

FIG. 1 is a partial sectional view of an electron emission device according to a first embodiment of the present invention.

As shown in FIG. 1, the electron emission device includes first substrate 10 and second substrate 20 facing each other with a predetermined distance therebetween. A plurality of spacers 30 are arranged between the first substrate 10 and the second substrate 20 so as to space them apart from each other by a predetermined distance, and the first substrate 10 and the second substrate 20 are sealed to each other at their peripheries using a sealant (not shown). The inner space between the first and the second substrates 10 and 20, respectively, is exhausted to thereby form a vacuum cell.

An electron emission unit 40 is provided at the first substrate 10 to produce electron emission, and a light emission unit 50 is provided at the second substrate 20 to emit visible rays due to the electrons, thereby displaying the desired images.

Gate electrodes 11 are stripe-patterned on the first substrate 10 in a direction of the first substrate 10, and an insulating layer 12 is formed on the entire surface of the first substrate 10 while covering the gate electrodes 11. Cathode electrodes 13 are stripe-patterned on the insulating layer 12 while being perpendicular to the gate electrodes 11.

In this embodiment, when the crossed regions of the gate electrodes 11 and the cathode electrodes 13 are defined as the pixel regions, electron emission regions 14 are formed on the one-sided peripheries of the cathode electrodes 13 at the respective pixel regions.

The electron emission regions 14 are formed of a material which emits electrons under the application of an electric field, such as a carbonaceous material and a nanometer-sized material. The electron emission regions 14 are, preferably, formed with carbon nanotube, graphite, graphite nanofiber, diamond, diamond-like carbon, C₆₀, silicon nanowire, or a combination thereof. The electron emission regions 14 may be formed through screen printing, direct growth, chemical vapor deposition, or sputtering.

As explained above, gate electrodes 11 are placed under the cathode electrodes 13, but it is also possible for the gate electrodes 11 to be placed over the cathode electrodes. In the latter case, opening portions are formed at the gate electrodes and the insulating layer to provide the respective pixel regions, and electron emission regions are formed on the cathode electrodes within the opening portions. Illustration of the latter case in the drawings is omitted for the sake of brevity.

Counter electrodes (not shown) are formed between the cathode electrodes 13 such that they are spaced apart from the respective electron emission regions 14. The counter electrodes attract the electric field of the gate electrodes 11 through the insulating layer 12, thereby forming higher intensity electric fields around the electron emission regions.

Black layers 21 are formed on a surface of the second substrate 20 facing the first substrate 10, the black layers 21 being spaced apart from each other to enhance the contrast, and reflective layers 22 are formed on the black layers 21. Phosphor layers 23 are formed on the surface of the second substrate 20 between the neighboring reflective layers 22, as well as on the lateral sides of the reflective layers 22, with red, green and blue phosphors. Furthermore, an anode electrode 24 is formed of an aluminum (Al)-based metallic thin film on the entire surface of the second substrate 20 while covering the phosphor layers 23 and the reflective layers 22.

The reflective layer 22 is formed with an achromatic color such that it is not mixed with the light emission color of the phosphor layer 23, and reflective layer 22 has a thickness larger than that of the black layer 21 such that the light emission area of the phosphor layer 23 is enlarged. The reflective layer 22 is preferably formed with a white color material, such as a mixture of a white-colored oxide of aluminum oxide (Al₂O₃) or titanium oxide (TiO₂), and glass.

The phosphor layers 23 are stripe-patterned or separately formed in correspondence to the pixel regions defined on the first substrate 10. In the latter case, the phosphor layers 23 are formed with various patterns, such as those of a polygon, a circle and an oval, and black layers 21 and reflective layers 22 are formed on a portion of the surface of the second substrate 20 having no phosphor layer 23.

A grid electrode (not shown) is disposed between the first and second substrates 10 and 20, respectively, with a plurality of beam passage holes corresponding to the electron emission regions 14. The grid electrode is formed with a meshed thin metallic plate. The grid electrode may be disposed between the two substrates while being supported by the spacers, or may be fitted to the topmost area of the structure of the first substrate 10.

The above-structured electron emission device is driven by applying predetermined voltages to the gate electrodes 11, the cathode electrodes 13 and the anode electrode 24. For instance, a plus (+) voltage of several to several tens of volts is applied to the cathode electrodes 13 as a scanning voltage, a minus (−) voltage of several to several tens of volts is applied to the gate electrodes 11 as a data voltage, and a plus voltage (+) of several hundreds to several thousands of volts is applied to the anode electrode 24.

Accordingly, electric fields are formed around the electron emission regions 14 at the pixels where the voltage difference between the cathode electrodes 13 and the gate electrodes 11 reaches a threshold value or more, and electrons are emitted from the electron emission regions 14. The emitted electrons are attracted by the high voltage applied to the anode electrode 24, and they collide against the corresponding phosphor layers 23, thereby light-emitting the layers 23.

As the phosphor layers 23 are formed on the surface of the second substrate 20 as well as on the lateral sides of the reflective layers 22, they produce widened effective light emission area. Accordingly, even if some electrons suffer energy loss while passing the anode electrode 24, the electrons passing the anode electrode 24 light-emit the phosphor layers 23 with a wide effective light emission area, thereby enhancing light emission efficiency.

Furthermore, the metallic thin film-based anode electrode 24 and the reflective layers 22 formed between the neighboring phosphor layers 23 increase the visible rays reflected toward the second substrate 20, thereby enhancing the light emission efficiency.

Consequently, with the electron emission device according to the first embodiment of the present invention, even if a low voltage of 4 kV is applied to the anode electrode 24, light emission efficiency is heightened due to the structure of the phosphor layers 23 and the reflective layers 22, and the diode light emission due to the anode electric field is inhibited, thereby preventing display failure.

FIG. 2 is a partial sectional view of an electron emission device according to a second embodiment of the present invention.

As shown in FIG. 2, in a second embodiment of the invention, the anode electrode 24′ may be formed of a transparent conductive film, such as indium tin oxide (ITO), instead of a metallic thin film. In this case, the anode electrode 24′ is first formed on a surface of the second substrate 20, and the phosphor layers 23, the black layers 21 and the reflective layers 22 are then formed on the anode electrode 24′.

Alternatively, although not illustrated in the drawings, an anode electrode based on a transparent conductive film, and an anode electrode based on a metallic thin film, may both be formed on the second substrate 20.

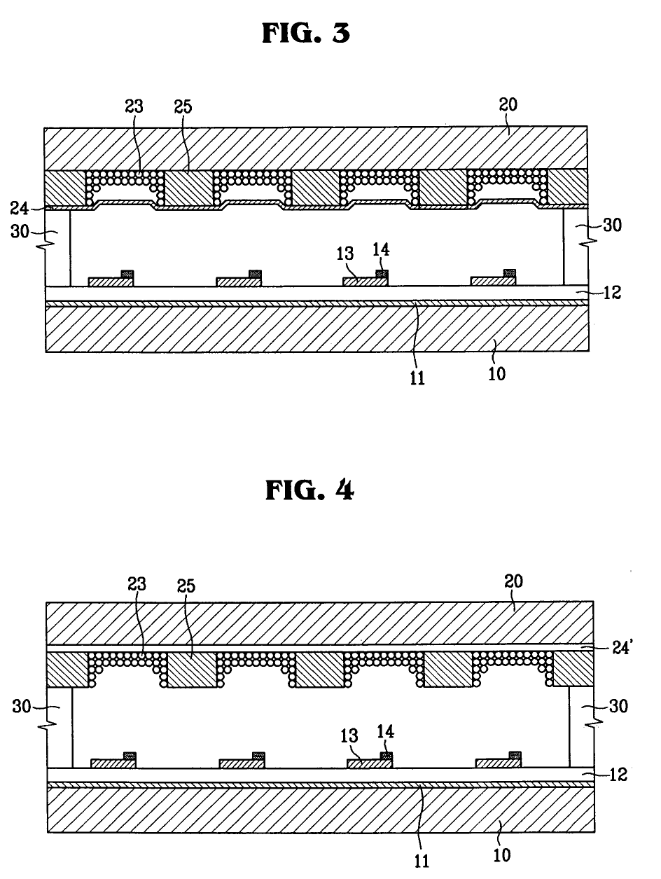

FIG. 3 is a partial sectional view of an electron emission device according to a third embodiment of the present invention.

With an electron emission device according to a third embodiment of the present invention, as shown in FIG. 3, a reflective layer is not formed on the second substrate 20, and the black layers 25 are placed at a plane higher than that of the phosphor layers 23. Accordingly, the phosphor layers 23 are formed on the surface of the second substrate 20 between the two neighboring black layers 25 and on the lateral sides of the two black layers 25.

With the above structure, since the phosphor layer 23 has a wide effective light emission area, even though some electrons suffer energy loss while passing the anode electrode 24, the electrons passing the anode electrode 24 light-emit the phosphor layer 23 with a wide effective light emission area, thereby enhancing light emission efficiency.

FIG. 4 is a partial sectional view of an electron emission device according to a fourth embodiment of the present invention.

In the fourth embodiment, as shown in FIG. 4, the anode electrode 24′ is formed with an ITO-based transparent conductive film, instead of a metallic thin film. In this case, the anode electrode 24′ is first formed on a surface of the second substrate 20, and phosphor layers 23 and black layers 25 are formed on the anode electrode 24′.

Alternatively, although not illustrated in the drawings, an anode electrode based on a transparent conductive film and an anode electrode based on a metallic thin film may be all formed on the second substrate.

It is explained that, with the FEA type electron emission device, the electron emission regions are formed with a material which emits electrons under the application of an electric field, and cathode and gate electrodes are provided as the driving electrodes. The inventive structure is not limited to the FEA type electron emission device, but may be easily applied to the SCE type, the MIM type, and the MIS type electron emission devices.

Although preferred embodiments of the present invention have been described in detail hereinabove, it should be clearly understood that many variations and/or modifications of the basic inventive concept herein taught may appear to those skilled in the art, and will still fall within the spirit and scope of the present invention, as defined in the appended claims.

1. An electron emission device, comprising:
a substrate;
a plurality of reflective layers formed on a surface of the substrate; and
phosphor layers formed on the surface of the substrate between neighboring reflective layers.

2. The electron emission device of claim 1, wherein the reflective layers are formed of an achromatic color.

3. The electron emission device of claim 2, wherein the reflective layers are formed of a white color.

4. The electron emission device of claim 3, wherein the reflective layers are formed of a mixture of a white-colored oxide and glass, and the white-colored oxide is selected from a group consisting of aluminum oxide and titanium oxide.

5. The electron emission device of claim 1, wherein the phosphor layers are further formed on lateral sides of the reflective layers.

6. The electron emission device of claim 1, further comprising an anode electrode formed of a metallic material on an entire surface of the substrate such that the anode electrode comprises a metallic material-based anode electrode which covers the phosphor layers and the reflective layers.

7. The electron emission device of claim 1, further comprising an anode electrode formed of a transparent material on a surface of the phosphor layers and the reflective layers facing the substrate.

8. The electron emission device of claim 1, further comprising black layers disposed between the substrate and the reflective layers.

9. An electron emission device, comprising:
a substrate;
a plurality of black layers formed on a surface of the substrate; and
phosphor layers formed on the surface of the substrate between the black layers and on lateral sides of the black layers.

10. The electron emission device of claim 9, further comprising an anode electrode formed of a metallic material on an entire surface of the substrate such that the anode electrode comprises a metallic material-based anode electrode which covers the phosphor layers and the black layers.

11. The electron emission device of claim 9, further comprising an anode electrode formed of transparent material on a surface of the phosphor layers and the black layers facing the substrate.

12. An electron emission device, comprising:
a first substrate having an electron emission unit for emitting electrons; and
a second substrate facing the first substrate and having a light emission unit for emitting visible rays due to the electrons emitted by the electron emission unit;
wherein the light emission unit comprises:
a plurality of reflective layers formed on a surface of the second substrate facing the first substrate; and
phosphor layers formed on the second substrate between the reflective layers.

13. The electron emission device of claim 12, wherein the reflective layer is formed of an achromatic color.

14. The electron emission device of claim 13, wherein the reflective layer is formed of a white color.

15. The electron emission device of claim 14, wherein the reflective layer is formed of a mixture of a white-colored oxide and glass, and the white-colored oxide is selected from a group consisting of aluminum oxide and titanium oxide.

16. The electron emission device of claim 12, wherein the phosphor layer is further formed on lateral sides of the reflective layers.

17. The electron emission device of claim 12, further comprising an anode electrode formed of a metallic material on an entire surface of the second substrate such that the anode electrode comprises a metallic material-based anode electrode which covers the phosphor layers and the reflective layers.

18. The electron emission device of claim 12 further comprising an anode electrode formed of a transparent material on a surface of the phosphor layers and the reflective layers facing the substrate.

19. The electron emission device of claim 12, further comprising black layers disposed between the second substrate and the reflective layers.

20. An electron emission device, comprising:
a first substrate having an electron emission unit for emitting electrons; and
a second substrate facing the first substrate and having a light emission unit for emitting visible rays due to the electrons emitted by the electron emission unit;
wherein the light emission unit comprises:
a plurality of black layers formed on a surface of the second substrate facing the first substrate; and
phosphor layers formed on the surface of the second substrate between the black layers and on lateral sides of the black layers.
